(19) United States
(12) Patent Application Publication
(10) Pub. No.: US 2009/0042632 A1
(43) Pub. Date: Feb. 12, 2009

(54) Novel Global Communication Network for Entertainment, Advertising and Social Gathering

(75) Inventors: Joachim Guenster, Baldham (DE); Thomas Binzinger, Baldham (DE)

Correspondence Address: AC TECHNOLOGIES, S.A., MAISON 2, LEITHUM, 9910, LU

(73) Assignee: AC TECHNOLOGIES S.A., Leithum (LU)

(21) Appl. No.: 12/186,532

(22) Filed: Aug. 6, 2008

Related U.S. Application Data
(60) Provisional application No. 60/954,579, filed on Aug. 8, 2007.

(51) Int. Cl. G06F 15/177; G06Q 30/00; A63F 9/24

(52) U.S. Cl. 463/17; 709/220; 705/14

(57) ABSTRACT

The present invention provides a method for creating a communication network for entertainment, advertising and social gathering services by using mobile devices that communicate automatically with each other via short-range communication means in a system based on peer-to-peer technology. The method enables to operate different applications in a network without having a central provider and without geographical limitations.

### CROSS-REFERENCE TO RELATED APPLICATIONS

This application claims priority from U.S. Provisional Patent Application Ser. No. 60/954,579, filed on 8 Aug. 2007 and entitled Novel Global Communication Network for Entertainment, Advertising and Social Gathering, the contents of which are hereby fully incorporated by reference.

### BACKGROUND OF THE INVENTION

1. Field of the Invention

The present invention relates to mobile networking applications.

2. Description of the Related Art

Match games are not new. Already in year 1962, the British Broadcasting Corporation (BBC) premiered “The match game”, created by Frank Wayne continuing through 1969 on NBC for 1,760 episodes. The gameplay of The Match Game consisted of a two three-person teams (one celebrity and two contestants) attempted to match answers to simple fill-in-the-blank questions, like “To a millionaire, dollars is nothing,” or “Name something you can open and shut.” Two matching answers earned $25 for the team, and if all three answers matched, the team earned $50. The winning team moved on to a bonus round, the “audience match,” and would guess the answers to a recent audience survey (“We asked 100 women, ‘How much money should you spend for a hat?’”). Each teammate would think of an answer they felt was given most frequently by the audience, with each match being worth $50; thus, the top possible payout was $450.

This original game gave birth to many other variations of match games. Many decades later, social networking websites have implemented the same basic idea to create matching networks online. The idea is to help people to find other people sharing interests, activities, needs or lifestyle in networks visited by billion of internet users worldwide.

Although most of these services are web-based, social networking websites are expanding their business through the use of mobile communication networks. This is mainly due to the widespread use of mobile phones and more recently of “smart phones”, the fastest-growing new category of mobile phones, featuring calendars, e-mail, pictures, music, games, browsers, and many others. These features make mobile networks especially attractive to develop social networking applications. Additionally, the release of high-speed wireless data-transmission technologies and peer-to-peer (P2P) allow network service designers to develop new applications for mobile devices.

Nevertheless, many of these networking applications would expand much faster if mobile users would be able to further distribute them. In this respect, mobile users face the limitations of short-range communications technologies when willing to transmit data packages to other mobile devices.

Therefore there is a need to develop applications that overcome the above distribution problem between devices equipped with short-range communication means. The present invention relates to a method for creating mobile communication networks that uses peer-to-peer technology to expand the limited range of the communications means of mobile devices. The method uses mobile devices as repeaters and temporally storage locations. The method enables to operate different advertising, entertainment and social gathering mobile applications in a network without having a central provider and without geographical limitations.

### SUMMARY OF THE INVENTION

The present invention provides a method for creating mobile communication networks for entertainment, advertising and social gathering services by using mobile devices that communicate automatically with each other via short-range communication means in a system based on peer-to-peer technology.

### DETAILED DESCRIPTION OF THE INVENTION

Embodiments of the present invention implement applications to information exchanged between mobile devices via short-range communication means. In this specification, the term “mobile device” refers to portable apparatus such as cellphones or personal digital assistants (PDAs) while “short-range communication means” or simply “communication means” are used as synonyms and refer to any wireless data communication technology that operates in a short-range mode including, without being limited to, Bluetooth. In the present invention, limitations relating to the low-transmission range of such communication means are overcome by using mobile devices as hop or retransmission station to other mobile devices in the network. This allows for communication between such mobile devices without geographical limitations as the system extends the network area originally restricted by the low-transmission range of the communication means. In this specification, the term “extended network area” refers to a network in which mobile devices are used as repeaters of other users' signals whereas “restricted network area” refers to the network created within the range of the communication means without further retransmission of the signals by the mobile devices. Embodiments of the invention are useful for entertainment, advertising and social gathering.

The communication network comprises a multiplicity of mobile devices having storage means and equipped with at least one short-range communication means e.g. Bluetooth. Mobile devices are coupled for data communications via short-range communication means. Suitable programming means stored on such mobile devices implement the different applications of the invention based on the information exchanged between users. In this specification, the terms “software”, “software application” and “programming means” are used as a synonyms referring to any means for directing the system to execute the steps of the different applications of the invention.

A first aspect of the invention is an embodiment in which the profile of the owner of a mobile device (A) is created and subsequently stored on it. The profile contains requirements and attributes of its owner. The profile of A is sent to the next mobile device (B) located within the range of the communication means. Once the profile of A is stored in the mobile device B, the matching controller detects if there are any matches between profile A and B. The matching controller is a software application stored on the mobile device that allows for comparing the requirements of an user with the attributes of another user to detect a match. After this initial interaction between A and B, the profile of A remains stored on the mobile device of B. When the next mobile device (C) is located within its range, B sends its own profile to C and additionally retransmits the profile of A. Once profiles of A and B are stored on mobile device C, the matching controller detects if there are any matches between senders and receivers. In this embodiment, if profile A and C are a match, notification of the match is sent only to the owners of the matching profiles (A and C) while B acted as a mere carrier of the profile of A.

As explained above, in addition to the profile of the user, any received matching or not matching profile remains stored on the user's mobile device. These stored profiles are sent to other mobile devices located within the range of the communication means of the recipient mobile device. Programming means detect if there are any matches between profiles. This storage and retransmission of profiles as well as the match detection function creates a network of profile matching wherein the retransmission function based on peer-to-peer technology exponentially increases the probability that matching profiles are detected.

The method implements software that is stored and executed on the mobile device to enable such pattern. Once the application is started, the mobile device seeks signals from other mobile devices, stores other user's profiles sent by such mobile devices and initiates the match controller. If there is a match, both users are notified by the method of their choice. This method may be, without being limited to, SMS, vibration alarm, direct call, or email.

In another embodiment, pattern searching is not only executed by software stored on the mobile device but also by a pattern-searching online database. The mobile user sends its profile to a programmed computer attached to the communication network. Processing means stored on the computer execute the matching controller in order to find any matches with other user's profiles stored on the database. If there is a match, matching users are notified by the method of their choice (SMS, vibration alarm, email, etc). Simultaneously, the profile of the user is sent over the mobile network for pattern searching in an extended network area. This allows for the creation of a global matching network in which matches are not only provided by pattern searching through the mobile network but also by the online database.

Information contained on the user's profile depends on the different applications implemented by this method. In some applications, the user's personal profile may be required. For example, in one of the embodiments, the network serves as a dating service. In this case, profiles contains information on the specific physical and personal attributions that participants wish to find.

The method also allows for searching members of a specific group. In this application, a company, institution, association or any other entity using the service issues a token, which is a special serie of bits that are passed over the network. The token is then downloaded to the mobile devices of the members. As the token circulates, other member's mobile devices can capture it. This enables the localization of members of the same group within the range of the communication means. The system sends a notification to the member's mobile device when another member of the same group is within its range. The application is addressed to members of sport or fans clubs, employees of a company, collectors or people with common interests, like but not limited to, people with the same hobbies, literature or political preferences.

A further application of the method allows for matching opposite profiles like those of buyers and sellers of a specific item. The application may also allow for finding a single person in the crowd, like the speaker in a conference room.

In another embodiment, the communication network comprises also a based station. This based station may be a mobile device but in this case, the originally portable device is fixed to a specific location where it remains stationed. In this embodiment, the based station stores information about products or services of a provider and identifies mobile devices carried for people walking within its range. According to the profile of the person, shopping preferences, club memberships or any other relevant information, programming means of the system send a targeted electronic ad according to the provider information stored on the based station. The electronic ad may advertise a product, offer a service or inform about discounts. Electronic ads are only sent to mobile devices subscribed to this information service. These mobile devices also act as carriers of the received information, retransmitting the invitation to other mobile devices that are subscribed to the service but are located out of the range of the based station. In this case, the sender mobile device may perform a match controller application to secure that the electronic ad is sent to a mobile device storing a similar profile to the one of the carrier. By way of example only, if a provider offers discounts in female clothes, the mobile device retransmitting the electronic ad performs the match controller application to secure that the owner of the receiver mobile device is a woman. This allows for correctly retransmitting targeted ads and implementing the service in an extended network area. The service may be used, without being limited to, by restaurants, tourist industry and shops.

Another application of the method relates to entertainment applications that involve a large number of participants. The service is addressed to companies looking for new games for promotions or media producers seeking new games to attract viewers. One of the uses of this application relates to “superstar search”. A number of mobile phones enroll in the game. Players send their pictures to mobile phones that are in their proximity. Each player collects nine (9) pictures and deletes three (3), leaving three (3) open slots for new pictures. The winner is the person whose picture appears in the highest number of mobile phones. The application may be used in the same way for brand names searching, winner decisions in television and radio shows and local events. This application may be implemented either in a restricted or in an extended network area.

The method may be also used for lottery. In this embodiment, a variety of lottery game types are stored in the system as well as information and options corresponding to each of the game types. Programming means are configured to receive and process the player's information and drawing prizes according to the game type selected. The system allows game providers to attach marketing content to the electronic play card (token). In a first type of game, the entity organizing the lottery sends out for example 10 differentially coded tokens to 10 different mobile devices of the network. Tokens are subsequently transmitted from one mobile device to the next. Each token represents a different chain. The winner(s) is the mobile device having a determined number in the chain. The same player may also receive different tokens and therefore participate in different chains. The game is then programmed in a way in which players win when a specific combination of tokens is received in their mobile device. Programming means of the system determine which combination of tokens match for a prize and the odds or matching the tier combinations. By way of example only, token A is retransmitted 200 times. Programming means of the system determine that retransmission number 200 of token A matches for a prize when meeting retransmission number 100 of token B in the same mobile device. In another game type, the system issues a token containing a question like for example, a riddle. The user sends the answer via SMS and receives a confirmation SMS consisting of a lottery number. The lottery prize is then draw on a television or radio show, for example. Applications described above may be used by television and radio shows, printed media, brand names or for corporate events and promotions either in a restricted or in an extended network area. It is to be understood that the above examples are not intended to limit the types of games that may be offered in connection with the system.

What is claimed is:

1. A method of creating a communication network for matching profiles of network users, comprising the steps of:
(a) registering a plurality of mobile devices to the communication network, said mobile devices having storage and processing means and being equipped with short-range communication means, said short-range communication means allowing mobile devices to communicate with each other;
(b) storing at least one profile of the network user on each of said mobile devices, wherein the said at least one profile contains predetermined attributes and requirements of the network user;
(c) storing a matching controller on said mobile devices;
(d) sending stored profiles over the communication network, wherein the receiver mobile device is located within the range of communication of the sender mobile device; said mobile devices communicating with each other by using said short-range communication means;
(e) storing the said at least one received profile on the recipient mobile device;
(f) using said matching controller to register a match between the received profile and the said at least one profile stored on said recipient mobile device, said matching controller establishing a match when attributes of said at least one received profile match the requirements contained in the said at least one profile of the recipient mobile device.
(g) retransmitting said at least one received profile and said at least one profile stored on the recipient mobile device to other mobile devices of the network located within the range of communication of the recipient mobile device; wherein said recipient mobile device act as a carrier of the received profile; and
(h) sending a match notification to the owners of matching profiles, wherein mobile devices acting as carriers of any of the matching profiles do not receive said notification.

2. The method according to claim 1, wherein mobile devices of the network further communicate with a programmed computer; said computer storing profiles of network users; said computer executing a matching controller to match profiles of network users; said computer sending match notifications to network users.

3. The method according to claim 1, wherein profiles are sent within a specific group of network users; said group being created by generating a token to be downloaded to the mobile device attached to the group; said token allowing to receive profiles from other members of the group.

4. The method of claim 1, further including advertising content attached to match notifications sent over the network.

5. A method for creating a communication network for advertising, comprising the steps of:
(a) registering a based station to the communication network, said based station having storage and processing means and being equipped with short-range communication means;
(b) storing an advertising software application and at least one provider profile on the based station,
(c) registering a plurality of mobile devices to the communication network, said mobile devices having storage and processing means and being equipped with short-range communication means, said short-range communication means allowing mobile devices to communicate with each other and with said based station;
(d) storing at least one profile of the network user on each of said mobile devices, wherein the said at least one profile contains predetermined attributes and requirements of the user;
(e) detecting registered mobile devices located within the range of communication of the based station, said based station receiving said at least one profile stored on each said mobile devices after detection;
(f) generating an electronic ad, said electronic ad generated according to user and provider profiles by the advertising software application;
(g) sending the targeted electronic ad to the mobile device of the user;
(h) storing the received electronic ad on the recipient mobile device; and
(i) retransmitting the electronic ad to other mobile devices of the network located within the range of communication of said recipient mobile device and outside the range of communication of the based station;
whereby the mobile device retransmitting the electronic ad may perform a match controller application to secure that said electronic ad is sent to mobile devices storing similar profiles to the one stored on the retransmitting mobile device.

6. A method for creating a communication network for lottery gaming, comprising the steps of:
(a) registering a plurality of mobile devices to the communication network, said mobile devices having storage and processing means and being equipped with short-range communication means, said short-range communication means allowing mobile devices to communicate with each other;
(b) attaching at least one programmed computer to the communication network, said computer comprising storage and processing means, wherein said computer is adapted to communicate with said mobile devices via short-range communication means;
(c) storing at least one game application in said programmed computer;
(d) storing at least one profile of the network user on each of said mobile devices, wherein the said at least one profile contains predetermined attributes and requirements of the user;
(e) generating a token to be sent to mobile devices of the network, said token containing instructions to execute the game application on the mobile devices of the network users; and
(f) retransmitting received tokens to registered mobile devices located outside the range of communication of the programmed computer.
